(19) United States
(12) Patent Application Publication
(10) Pub. No.: US 2025/0388999 A1
(43) Pub. Date: Dec. 25, 2025

(54) HIGH ENTROPY BORIDE-PLATINUM GROUP METAL ALLOYS AND USES THEREOF

(71) Applicant: Research Foundation for SUNY, Albany, NY (US)

(72) Inventors: Michael T. Yeung, Albany, NY (US); Juncheng Li, Albany, NY (US); Abraham A. Rosenberg, Albany, NY (US); Ting Wang, Albany, NY (US)

(21) Appl. No.: 19/249,875

(22) Filed: Jun. 25, 2025

Related U.S. Application Data
(60) Provisional application No. 63/663,802, filed on Jun. 25, 2024.

(51) Int. Cl. C22C 21/00; B01J 23/648; B22F 3/10; B22F 3/24; B22F 9/04; C22C 1/04

(52) U.S. Cl. CPC C22C 21/00; B01J 23/6486; B22F 3/10; B22F 3/24; B22F 9/04; C22C 1/0416; B22F 2003/248; B22F 2301/052; B22F 2998/10; B22F 2999/00

(57) ABSTRACT

High entropy boride-platinum group metal alloys and uses thereof are described. The high entropy boride-platinum group metal alloys can include boron, a platinum group metal, and additional metals, such as aluminum (Al), niobium (Nb), tantalum (Ta), and/or titanium (Ti). The high entropy boride-platinum group metal alloys have multiple uses and provide high catalytic activity and sulfur resistance.

### CROSS-REFERENCE TO RELATED APPLICATIONS

This application claims the benefit of U.S. Provisional Patent Application No. 63/663,802, filed Jun. 25, 2024, which is incorporated herein by reference in its entirety.

### FIELD OF THE DISCLOSURE

The current disclosure provides high entropy boride-platinum group metal alloys and uses thereof. The high entropy boride-platinum group metal alloys can include boride, a platinum group metal, and additional metals, such as aluminum (Al), niobium (Nb), tantalum (Ta), and/or titanium (Ti). The high entropy boride-platinum group metal alloys have multiple uses and provide high catalytic activity and sulfur resistance.

### BACKGROUND

MXenes refer to a family of conductive two-dimensional carbides, nitrides, and carbonitrides. MXenes have a variety of uses in electronics, optics, catalysis, electrochemical capacitance, and biomedical, structural, and environmental applications.

Boron is a second row main group element with a tendency to catenate forming a high density of covalent bonds and a high shear modulus. These strong boron-boron bonds can serve as a covalent framework for, for example, other metals. Additionally, boron is a Lewis acid, which contributes to intercalation. Based on these characteristics, boron can be considered as a scaffold or canvas for incorporating metals into alloys.

Alloying and solid-solution formation is a powerful technique that enhances and adds properties through elemental mixing, but unfortunately, some elements simply cannot mix as their chemical nature prevents a thermodynamically stable structure. For example, the inherent nobility of platinum group metals (i.e, platinum, rhodium, palladium, ruthenium, iridium, and osmium) does not favor bond formation and precludes their incorporation into higher (boron-rich) metal borides.

### SUMMARY OF THE DISCLOSURE

The current disclosure provides MBenes, the boron equivalent of MXenes. In particular embodiments, MBenes have a qausi-two dimensional structure where boron planes are stitched together by metal atoms, constituting a mixture of covalent and ionic bonding.

In particular embodiments, the current disclosure provides high entropy boride-platinum group metal alloys. The high entropy boride-platinum group metal alloys can include boron, a platinum group metal (e.g, platinum, rhodium, palladium, ruthenium, iridium, and osmium), and additional metals, such as aluminum (Al), niobium (Nb), tantalum (Ta), and/or titanium (Ti). In particular embodiments, the high entropy boride-platinum group metal alloy can include Al_{0.2}Nb_{0.2}Pt_{0.2}Ta_{0.2}Ti_{0.2}B₂, the highest boron-coordinating platinum in borides to date.

The high entropy boride-platinum group metal alloys disclosed herein have multiple uses including in electronics, optics, catalysis, electrochemical capacitance, pesticides, dyes, and pharmaceuticals, as well as biomedical, structural, and environmental applications. In particular embodiments, the boron-platinum group metal alloys disclosed herein provide high catalytic activity and sulfur resistance.

### BRIEF DESCRIPTION OF THE DRAWINGS

FIG. 1 illustrates a crystal lattice of the high entropy diboride (HEB) system. Grey spheres represent boron atoms, whereas shaded wheels represent the random distribution of metals, aluminum (Al), niobium (Nb), platinum (Pt), tantalum (Ta), and titanium (Ti).

FIG. 2 illustrates the powder x-ray diffraction (pXRD) pattern of Al_{0.2}Nb_{0.2}Pt_{0.2}Ta_{0.2}Ti_{0.2}B₂. Note the three sharp peaks of the HEB with their labeled Miller Indices indicative of an MB₂ structure. The SiO₂ and AlB₂ peaks are indicated by their corresponding arrows.

FIG. 3 illustrates pXRD of the product of heating 0.2 Al+0.2 Nb+0.2 Pt+0.2 Ta+0.2 Ti+2 B directly from the elements using the same heating profile as described in the Experimental Methods. While there does appear to be some diboride phase formation, note the presence of unreacted platinum which reflects platinum group metals' inherent unreactivity.

FIG. 4 illustrates pXRD pattern of HEB Al_{0.4}Nb_{0.2}Ta_{0.2}Ti_{0.2}B₂.

FIG. 5 illustrates pXRD pattern of decomposed Al_{0.8}Pt_{0.2}B₂, suggesting that traditional solid solution stabilization routes are not enough to overcome platinum's chemical nobility as only decomposed platinum metal products remain.

FIG. 6 illustrates a scanning electron microscopy (SEM) image of Al_{0.2}Nb_{0.2}Pt_{0.2}Ta_{0.2}Ti_{0.2}B₂ demonstrating highly crystalline particles with clearly defined facets.

FIG. 7 illustrates energy dispersive X-ray spectroscopy (EDS) mapping of the elemental composition of the HEB which suggests an even distribution of metals.

### DETAILED DESCRIPTION

Traditional metal alloys enable the enhancement of bulk properties through the simple addition of small amounts of additional elements. For example, stainless steel employs an alloy of chromium to add corrosion resistance. However, what limits the formation of alloys is the Hume-Rothery rules for solid solution formation, where the chemical character of the alloying elements must be similar, i.e. the crystal structure must be the same, the metallic radii must be close in size (preventing unnecessary strain), and the electronegativity/number of valence electrons should be similar for electron balancing. These rules are manifestations of the chemical nature of the elements as the unique character of each transition metal dictates their behavior, and these restrictions are exacerbated when compounds with non-metallic elements with their proclivities for coordination environments are considered.

This can be seen in many systems including borides and platinum group metals (i.e, platinum, rhodium, palladium, ruthenium, iridium, and osmium). Platinum group metals are noble and stubbornly refuse to form bonds with most main group elements. In fact, in a solid-state laboratory, platinum is often used as a crucible, due to its inherent inert nature. For example, platinum carbides questionably exist, platinum oxides readily reduce back to platinum metal, and platinum nitrides are difficult to prepare. While platinum borides do exist, they are limited in coordination due to the aforementioned reluctance to bond with main group elements, and thus there are only three platinum borides in the phase diagram and one recently discovered phase: Pt₃B₂ (Pt coordinated by 6 borons), PtB (Pt coordinated by 6 borons), and Pt₂B (Pt coordinated by 3 borons) (Akopov, et al., Adv. Mater. 2017, 29 (21), 1604506). Even platinum boron intermetallics never exceed these coordinations as MPtₓB₂₋ₓ (M=Y, Yb) has only 2 coordinate B—Pt—B. Here, only boron-poor phases (“lower borides”) have been identified and boron-rich phases (“higher borides”) such as a diboride MB₂ (12 coordinate), tetraboride MB₄ (coordination varies but is high), or even dodecaboride MB₁₂ (20 coordinate) have yet to be identified (Akopov, et al., Adv. Mater. 2017, 29 (21), 1604506; Albert, et al., Angew. Chem. Int. Ed. 2009, 48 (46), 8640-8668; Albert, et al., Handbook of Solid State Chemistry; John Wiley & Sons, Ltd, 2017; pp 435-453).

Furthermore, chemical exploration of the boron-platinum phase space is fundamentally interesting because the incorporation of boron into platinum group metals should result in a remarkable enhancement of catalytic properties. Incorporating just one boron atom into a platinum cluster is predicted to significantly reduce platinum agglomeration and coating of carbonaceous coke, thus maintaining high catalytic activity (Dadras, et al., ACS Catal. 2015, 5 (10), 5719-5727). Metal (e.g., platinum) agglomeration and/or carbonaceous coke coatings can detected by, for example, the presence of extra peaks in a Powder X-ray diffraction (pXRD) analysis. Additional methods to detect metal agglomeration and/or carbonaceous coke coatings include X-ray Photoelectron Spectroscopy (XPS), Energy Dispersive X-ray Spectroscopy (EDS), X-ray Fluorescence (XRF), and Inductively Coupled Plasma Mass Spectrometry (ICP-MS).

Organic substrates containing sulfur pose a greater challenge when employing a metallic catalyst due to sulfur chemisorbing onto the surface of a metal. Sulfur poisoning deactivates a reaction from taking place altogether. Even a sulfur concentration at the ppm level can deactivate a metal catalyst (Bartholomew, et al., Advances in Catalysis; 1982; Vol. 31, pp 135-242; Oudar, Catal. Rev. 1980, 22 (2), 171-195). This effect can be explained by Hard-Soft Acid Base theory (HSAB) where the sulfur atom, a soft base, is attracted to the soft transition metal acid. The transition metals are softer as you move towards the more catalytically active and useful transition metals. Thus, the catalytically active Group X elements: nickel, palladium, and platinum become the most susceptible to adsorption when in the presence of sulfur (Oudar, Catal. Rev. 1980, 22 (2), 171-195). This is unfortunate as Group X elements are the best hydrogenation catalysts. Hydrogenation reactions typically utilize the group X elements to catalyze their reactions; molecules containing sulfur have created a challenge for chemists due to poisoning of the catalyst, halting the reaction from occurring (Bartholomew, et al., Advances in Catalysis; 1982; Vol. 31, pp 135-242). Intriguingly, borides have been identified as resistant to sulfur poisoning, likely attributed to boron's ‘hard’ nature (Wang, et al., Appl. Catal. Gen. 2000, 203 (2), 293-300).

In 1995, the concept of high entropy alloys was proposed by Yeh, whereby utilizing five or more principal elements can force the formation of a single phase; the “high entropy” comes into the picture due to their higher mixing entropy of its (e.g., ≥5) components, thermodynamically stabilizing a single solid phase compound that can overcome inherent chemical nature. Here, the Gibbs free energy of ΔG=ΔH−TΔS (where G is the Gibbs free energy, H is enthalpy, T is temperature, and S is entropy) where the larger TΔS will cause ΔG to become negative and thus facilitate a spontaneous formation for the high entropy alloy (Tsai, et al., Mater. Res. Lett. 2014, 2 (3), 107-123). Like traditional alloys, the alloyed elements can dictate unique properties into the matrix. Leading to the current disclosure, it was hypothesized that platinum's inherent chemical inertness and refusal to coordinate with main group elements in the solid state could be thermodynamically overcome through high entropy alloying. Accordingly, a newly synthesized high entropy boride which uses the increased mixing entropy to ‘force’ platinum into a diboride was explored.

In particular embodiments, the current disclosure provides a high entropy alloy (HEA) including boron and a platinum group metal (i.e, platinum, rhodium, palladium, ruthenium, iridium, or osmium). HEAs are oftentimes based on a multi-principal element alloy (MPEA), which includes a base alloy with significant proportions of several other metal elements (e.g., two (2) or more base elements that may or may not be in substantially equal concentrations). Increasing the number of elements permits maximization of configurational entropy to improve stability of disordered solid solution (SS) phases, thereby suppressing formation of intermetallic (IM) phases. Thus, HEAs present a vast compositional space to achieve outstanding functionalities that are not present in traditional alloys having only one or two principal elements.

By conventional definition, HEAs can be described as those with 5 or more principal elements. In particular embodiments, a principal element can be between 5 and 35 wt. %. In particular embodiments, HEAs are multimetallic alloys containing five or more metallic elements in close atomic proportions. In particular embodiments, HEAs combine multiple principal elements at an equal or near equal fraction. In particular embodiments, HEAs have high strength (e.g., above 600 MPa), especially at elevated temperatures (e.g., 1400° C.). The strength of a compound can be assessed using mechanical testing (e.g., Tensile, Hardness, Impact, Fracture). In particular embodiments, Yield strength (a form of Tensile testing) can be used. Yield strength refers to the stress (MPa) at which a material begins to permanently deform.

More particularly, in particular embodiments, the current disclosure provides that when using four, five or more constituents, higher mixing entropy overcomes the described chemical limitations of platinum to form a stable high entropy alloy, demonstrating the formation of new compounds with substituents that are seemingly impossible with a traditional metal alloying approach. In particular embodiments, the high entropy boride-platinum group metals disclosed herein have five or more constituents. In particular embodiments, the high entropy boride-platinum group metals disclosed herein have five constituents.

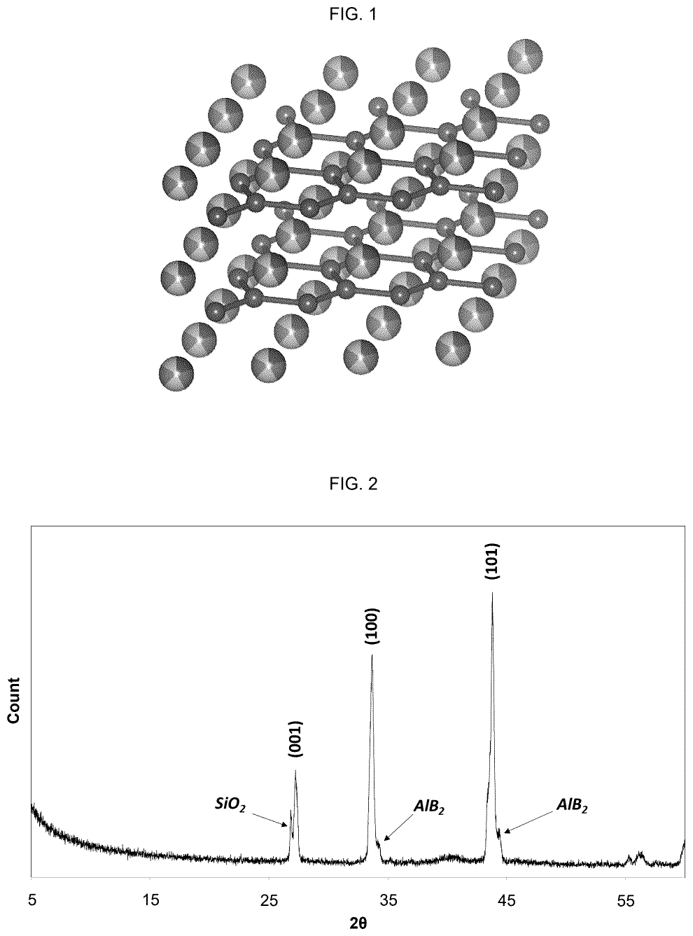

In particular embodiments, diborides crystallize into alternating sheets of boron and a metal (FIG. 1) and this layered structure contributes to extremely high catalytic activity and sulfur resistance (Golla, et al., Ultra-High Temperature Ceramics; John Wiley & Sons, Ltd, 2014; pp 316-360).

Particular embodiments disclosed herein include the high entropy boride (HEB) alloy: Al_{0.2}Nb_{0.2}Pt_{0.2}Ta_{0.2}Ti_{0.2}B₂. Al_{0.2} ND_{0.2}Pt_{0.2}Ta_{0.2}Ti_{0.2}B₂ was synthesized where platinum was forced to occupy a 12-coordinate site, sandwiched between honeycomb borophene sheets.

In addition to the unusual coordination, the boron serves as a poison panacea. Pure platinum is strongly susceptible to sulfur poisoning by adsorption, rendering a platinum catalyst ineffective. Boron is known to be resistant to sulfur poisoning, and the boron sheets present in the HEB shield the platinum from sulfur while maintaining high catalytic activity. This is confirmed with the facile hydrogenation of thiol-containing nitro compounds where the HEB resists sulfur poisoning while retaining its high catalytic activity. In particular embodiments, high catalytic activity can also be observed in relation to a relevant control in reducing, for example, 1-tert-butyl-4-nitrobenzene or 4-nitrothiophenol. In particular embodiments, the relevant control can include pure platinum or Al_{0.2}Nb_{0.2}Ta_{0.2}Ti_{0.2}B₂

This design targets the stabilization of a platinum-containing diboride, which did not exist before the current disclosure, by utilizing a high entropy alloyed system to allow for platinum incorporation alongside four other metals within the same diboride lattice.

In particular embodiments, it is demonstrated that when using five or more constituents, the higher mixing entropy overcomes chemical limitations and forms a stable high entropy alloy, demonstrating the formation of new compounds with substituents that are seemingly impossible with a traditional metal alloying approach.

The stability of a compound or alloy is apparent in the formation of a solid phase in a particular environment. In certain examples, pXRD can be used to determine the presence of compounds (i.e. if peaks are present then the compound is stable within an atmosphere). Techniques, such as XPS, Scanning Transmission Electron Microscopy with Energy-Dispersive X-ray Spectroscopy (STEM-EDX), and differential scanning calorimetry (DSC) can also be used. Stability can also indicate resistance to change (phase structure, decomposition, etc.), under various conditions such as temperature or electrochemical environments.

While Al_{0.2}Nb_{0.2}Pt_{0.2}Ta_{0.2}Ti_{0.2}B₂, the highest boron-coordinating platinum in borides to date, represents the preferred embodiment of the disclosed boride-platinum group metal alloys, the disclosure is not so limited. For example, other potential diboride compositions can include four metals chosen from a group including magnesium (Mg), scandium (Sc), titanium (Ti), vanadium (V), chromium (Cr), manganese (Mn), zirconium (Zr), niobium (Nb), hafnium (Hf), tantalum (Ta), and aluminum (Al), and a fifth catalytically active element such as rhenium (Re), ruthenium (Ru), osmium (Os), cobalt (Co), rhodium (Rh), iridium (Ir), nickel (Ni), palladium (Pd), platinum (Pt), copper (Cu), silver (Ag), and gold (Au). These compositions can provide benefits including resistance of catalyst poisoning, high catalytic activity, and enhanced hardness. For example, diboride compositions can include: Al, Cr, Hf, Mg; Al, Cr, Hf, Mn; Al, Cr, Hf, Nb; Al, Cr, Hf, Sc; Al, Cr, Hf, Ta; Al, Cr, Hf, Ti; Al, Cr, Hf, V; Al, Cr, Hf, Zr; Al, Cr, Mg, Mn; Al, Cr, Mg, Nb; Al, Cr, Mg, Sc; Al, Cr, Mg, Ta; Al, Cr, Mg, Ti; Al, Cr, Mg, V; Al, Cr, Mg, Zr; Al, Cr, Mn, Nb; Al, Cr, Mn, Sc; Al, Cr, Mn, Ta; Al, Cr, Mn, Ti; Al, Cr, Mn, V; Al, Cr, Mn, Zr; Al, Cr, Nb, Sc; Al, Cr, Nb, Ta; Al, Cr, Nb, Ti; Al, Cr, Nb, V; Al, Cr, Nb, Zr; Al, Cr, Sc, Ta; Al, Cr, Sc, Ti; Al, Cr, Sc, V; Al, Cr, Sc, Zr; Al, Cr, Ta, Ti; Al, Cr, Ta, V; Al, Cr, Ta, Zr; Al, Cr, Ti, V; Al, Cr, Ti, Zr; Al, Cr, V, Zr; Al, Hf, Mg, Mn; Al, Hf, Mg, Nb; Al, Hf, Mg, Sc; Al, Hf, Mg, Ta; Al, Hf, Mg, Ti; Al, Hf, Mg, V; Al, Hf, Mg, Zr; Al, Hf, Mn, Nb; Al, Hf, Mn, Sc; Al, Hf, Mn, Ta; Al, Hf, Mn, Ti; Al, Hf, Mn, V; Al, Hf, Mn, Zr; Al, Hf, Nb, Sc; Al, Hf, Nb, Ta; Al, Hf, Nb, Ti; Al, Hf, Nb, V; Al, Hf, Nb, Zr; Al, Hf, Sc, Ta; Al, Hf, Sc, Ti; Al, Hf, Sc, V; Al, Hf, Sc, Zr; Al, Hf, Ta, Ti; Al, Hf, Ta, V; Al, Hf, Ta, Zr; Al, Hf, Ti, V; Al, Hf, Ti, Zr; Al, Hf, V, Zr; Al, Mg, Mn, Nb; Al, Mg, Mn, Sc; Al, Mg, Mn, Ta; Al, Mg, Mn, Ti; Al, Mg, Mn, V; Al, Mg, Mn, Zr; Al, Mg, Nb, Sc; Al, Mg, Nb, Ta; Al, Mg, Nb, Ti; Al, Mg, Nb, V; Al, Mg, Nb, Zr; Al, Mg, Sc, Ta; Al, Mg, Sc, Ti; Al, Mg, Sc, V; Al, Mg, Sc, Zr; Al, Mg, Ta, Ti; Al, Mg, Ta, V; Al, Mg, Ta, Zr; Al, Mg, Ti, V; Al, Mg, Ti, Zr; Al, Mg, V, Zr; Al, Mn, Nb, Sc; Al, Mn, Nb, Ta; Al, Mn, Nb, Ti; Al, Mn, Nb, V; Al, Mn, Nb, Zr; Al, Mn, Sc, Ta; Al, Mn, Sc, Ti; Al, Mn, Sc, V; Al, Mn, Sc, Zr; Al, Mn, Ta, Ti; Al, Mn, Ta, V; Al, Mn, Ta, Zr; Al, Mn, Ti, V; Al, Mn, Ti, Zr; Al, Mn, V, Zr; Al, Nb, Sc, Ta; Al, Nb, Sc, Ti; Al, Nb, Sc, V; Al, Nb, Sc, Zr; Al, Nb, Ta, Ti; Al, Nb, Ta, V; Al, Nb, Ta, Zr; Al, Nb, Ti, V; Al, Nb, Ti, Zr; Al, Nb, V, Zr; Al, Sc, Ta, Ti; Al, Sc, Ta, V; Al, Sc, Ta, Zr; Al, Sc, Ti, V; Al, Sc, Ti, Zr; Al, Sc, V, Zr; Al, Ta, Ti, V; Al, Ta, Ti, Zr; Al, Ta, V, Zr; Al, Ti, V, Zr; Cr, Hf, Mg, Mn; Cr, Hf, Mg, Nb; Cr, Hf, Mg, Sc; Cr, Hf, Mg, Ta; Cr, Hf, Mg, Ti; Cr, Hf, Mg, V; Cr, Hf, Mg, Zr; Cr, Hf, Mn, Nb; Cr, Hf, Mn, Sc; Cr, Hf, Mn, Ta; Cr, Hf, Mn, Ti; Cr, Hf, Mn, V; Cr, Hf, Mn, Zr; Cr, Hf, Nb, Sc; Cr, Hf, Nb, Ta; Cr, Hf, Nb, Ti; Cr, Hf, Nb, V; Cr, Hf, Nb, Zr; Cr, Hf, Sc, Ta; Cr, Hf, Sc, Ti; Cr, Hf, Sc, V; Cr, Hf, Sc, Zr; Cr, Hf, Ta, Ti; Cr, Hf, Ta, V; Cr, Hf, Ta, Zr; Cr, Hf, Ti, V; Cr, Hf, Ti, Zr; Cr, Hf, V, Zr; Cr, Mg, Mn, Nb; Cr, Mg, Mn, Sc; Cr, Mg, Mn, Ta; Cr, Mg, Mn, Ti; Cr, Mg, Mn, V; Cr, Mg, Mn, Zr; Cr, Mg, Nb, Sc; Cr, Mg, Nb, Ta; Cr, Mg, Nb, Ti; Cr, Mg, Nb, V; Cr, Mg, Nb, Zr; Cr, Mg, Sc, Ta; Cr, Mg, Sc, Ti; Cr, Mg, Sc, V; Cr, Mg, Sc, Zr; Cr, Mg, Ta, Ti; Cr, Mg, Ta, V; Cr, Mg, Ta, Zr; Cr, Mg, Ti, V; Cr, Mg, Ti, Zr; Cr, Mg, V, Zr; Cr, Mn, Nb, Sc; Cr, Mn, Nb, Ta; Cr, Mn, Nb, Ti; Cr, Mn, Nb, V; Cr, Mn, Nb, Zr; Cr, Mn, Sc, Ta; Cr, Mn, Sc, Ti; Cr, Mn, Sc, V; Cr, Mn, Sc, Zr; Cr, Mn, Ta, Ti; Cr, Mn, Ta, V; Cr, Mn, Ta, Zr; Cr, Mn, Ti, V; Cr, Mn, Ti, Zr; Cr, Mn, V, Zr; Cr, Nb, Sc, Ta; Cr, Nb, Sc, Ti; Cr, Nb, Sc, V; Cr, Nb, Sc, Zr; Cr, Nb, Ta, Ti; Cr, Nb, Ta, V; Cr, Nb, Ta, Zr; Cr, Nb, Ti, V; Cr, Nb, Ti, Zr; Cr, Nb, V, Zr; Cr, Sc, Ta, Ti; Cr, Sc, Ta, V; Cr, Sc, Ta, Zr; Cr, Sc, Ti, V; Cr, Sc, Ti, Zr; Cr, Sc, V, Zr; Cr, Ta, Ti, V; Cr, Ta, Ti, Zr; Cr, Ta, V, Zr; Cr, Ti, V, Zr; Hf, Mg, Mn, Nb; Hf, Mg, Mn, Sc; Hf, Mg, Mn, Ta; Hf, Mg, Mn, Ti; Hf, Mg, Mn, V; Hf, Mg, Mn, Zr; Hf, Mg, Nb, Sc; Hf, Mg, Nb, Ta; Hf, Mg, Nb, Ti; Hf, Mg, Nb, V; Hf, Mg, Nb, Zr; Hf, Mg, Sc, Ta; Hf, Mg, Sc, Ti; Hf, Mg, Sc, V; Hf, Mg, Sc, Zr; Hf, Mg, Ta, Ti; Hf, Mg, Ta, V; Hf, Mg, Ta, Zr; Hf, Mg, Ti, V; Hf, Mg, Ti, Zr; Hf, Mg, V, Zr; Hf, Mn, Nb, Sc; Hf, Mn, Nb, Ta; Hf, Mn, Nb, Ti; Hf, Mn, Nb, V; Hf, Mn, Nb, Zr; Hf, Mn, Sc, Ta; Hf, Mn, Sc, Ti; Hf, Mn, Sc, V; Hf, Mn, Sc, Zr; Hf, Mn, Ta, Ti; Hf, Mn, Ta, V; Hf, Mn, Ta, Zr; Hf, Mn, Ti, V; Hf, Mn, Ti, Zr; Hf, Mn, V, Zr; Hf, Nb, Sc, Ta; Hf, Nb, Sc, Ti; Hf, Nb, Sc, V; Hf, Nb, Sc, Zr; Hf, Nb, Ta, Ti; Hf, Nb, Ta, V; Hf, Nb, Ta, Zr; Hf, Nb, Ti, V; Hf, Nb, Ti, Zr; Hf, Nb, V, Zr; Hf, Sc, Ta, Ti; Hf, Sc, Ta, V; Hf, Sc, Ta, Zr; Hf, Sc, Ti, V; Hf, Sc, Ti, Zr; Hf, Sc, V, Zr; Hf, Ta, Ti, V; Hf, Ta, Ti, Zr; Hf, Ta, V, Zr; Hf, Ti, V, Zr; Mg, Mn, Nb, Sc; Mg, Mn, Nb, Ta; Mg, Mn, Nb, Ti; Mg, Mn, Nb, V; Mg, Mn, Nb, Zr; Mg, Mn, Sc, Ta; Mg, Mn, Sc, Ti; Mg, Mn, Sc, V; Mg, Mn, Sc, Zr; Mg, Mn, Ta, Ti; Mg, Mn, Ta, V; Mg, Mn, Ta, Zr; Mg, Mn, Ti, V; Mg, Mn, Ti, Zr; Mg, Mn, V, Zr; Mg, Nb, Sc, Ta; Mg, Nb, Sc, Ti; Mg, Nb, Sc, V; Mg, Nb, Sc, Zr; Mg, Nb, Ta, Ti; Mg, Nb, Ta, V; Mg, Nb, Ta, Zr; Mg, Nb, Ti, V; Mg, Nb, Ti, Zr; Mg, Nb, V, Zr; Mg, Sc, Ta, Ti; Mg, Sc, Ta, V; Mg, Sc, Ta, Zr; Mg, Sc, Ti, V; Mg, Sc, Ti, Zr; Mg, Sc, V, Zr; Mg, Ta, Ti, V; Mg, Ta, Ti, Zr; Mg, Ta, V, Zr; Mg, Ti, V, Zr; Mn, Nb, Sc, Ta; Mn, Nb, Sc, Ti; Mn, Nb, Sc, V; Mn, Nb, Sc, Zr; Mn, Nb, Ta, Ti; Mn, Nb, Ta, V; Mn, Nb, Ta, Zr; Mn, Nb, Ti, V; Mn, Nb, Ti, Zr; Mn, Nb, V, Zr; Mn, Sc, Ta, Ti; Mn, Sc, Ta, V; Mn, Sc, Ta, Zr; Mn, Sc, Ti, V; Mn, Sc, Ti, Zr; Mn, Sc, V, Zr; Mn, Ta, Ti, V; Mn, Ta, Ti, Zr; Mn, Ta, V, Zr; Mn, Ti, V, Zr; Nb, Sc, Ta, Ti; Nb, Sc, Ta, V; Nb, Sc, Ta, Zr; Nb, Sc, Ti, V; Nb, Sc, Ti, Zr; Nb, Sc, V, Zr; Nb, Ta, Ti, V; Nb, Ta, Ti, Zr; Nb, Ta, V, Zr; Nb, Ti, V, Zr; Sc, Ta, Ti, V; Sc, Ta, Ti, Zr; Sc, Ta, V, Zr; Sc, Ti, V, Zr; or Ta, Ti, V, Zr in combination with Pt, Re, Ru, Os, Co, Rh, Ir, Ni, Pd, Cu, Ag, or Au.

In particular embodiments, constituents of high entropy boride-platinum group metal alloys disclosed herein are selected from aluminum (Al), niobium (Nb), tantalum (Ta), and/or titanium (Ti). In particular embodiments, of high entropy boride-platinum group metal alloys disclosed herein include Al. In particular embodiments, of high entropy boride-platinum group metal alloys disclosed herein include Nb. In particular embodiments, of high entropy boride-platinum group metal alloys disclosed herein include Ta. In particular embodiments, of high entropy boride-platinum group metal alloys disclosed herein include Ti.

In particular embodiments, of high entropy boride-platinum group metal alloys disclosed herein include Al and Nb. In particular embodiments, of high entropy boride-platinum group metal alloys disclosed herein include Al and Ta. In particular embodiments, of high entropy boride-platinum group metal alloys disclosed herein include Al and Ti. In particular embodiments, of high entropy boride-platinum group metal alloys disclosed herein include Nb and Ta. In particular embodiments, of high entropy boride-platinum group metal alloys disclosed herein include Nb and Ti. In particular embodiments, of high entropy boride-platinum group metal alloys disclosed herein include Ta and Ti.

In particular embodiments, of high entropy boride-platinum group metal alloys disclosed herein include Al, Nb, and Ta. In particular embodiments, of high entropy boride-platinum group metal alloys disclosed herein include Al, Nb, and Ti. In particular embodiments, of high entropy boride-platinum group metal alloys disclosed herein include Nb, Ta, and Ti. In particular embodiments, of high entropy boride-platinum group metal alloys disclosed herein include Al, Ta, and Ti.

In particular embodiments, of high entropy boride-platinum group metal alloys disclosed herein include Al, Nb, Ta, and Ti.

Additionally, atomic ratios of the high entropy boride-platinum group metal alloys may be adjusted, for example, within the range of Al_{0.17-0.23}Nb_{0.17-0.23}Pt_{0.17-0.23}Ta_{0.17-0.23}Ti_{0.17-0.23}B₂. Within these examples, each component of the high entropy boride-platinum group metal alloy can individually be any value within the atomic range of 0.17-0.23. The permissible ranges can be extended further, so long as the characteristics of the formed high entropy boride-platinum group metal alloy do not functionally deviate from characteristics defined and described herein.

Additional atomic relationships between components of disclosed high entropy alloys can include: Al_{0.18-0.21}Nb_{0.18-0.21}Pt_{0.18-0.21}Ta_{0.18-0.21}Ti_{0.18-0.21}B₂; Al_{0.18-0.21}Nb_{0.2}Pt_{0.2}Ta_{0.2}Ti_{0.2}B₂; Al_{0.2}Nb_{0.18-0.21}Pt_{0.2}Ta_{0.2}Ti_{0.2}B₂; Al_{0.2}Nb_{0.2}Pt_{0.18-0.21}Ta_{0.2}Ti_{0.2}B₂; Al_{0.2}Nb_{0.2}Pt_{0.2}Ta_{0.18-0.2}Ti_{0.2}B₂; Al_{0.2}ND_{0.2}Pt_{0.2}Ta_{0.2}Ti_{0.18-0.21}B₂; Al_{0.2}Nb_{0.18-0.21}Pt_{0.18-0.21}Ta_{0.18-0.21}Ti_{0.18-0.21}B₂; Al_{0.18-0.21}Nb_{0.2}Pt_{0.18-0.21}Ta_{0.18-0.21}Ti_{0.18-0.21}B₂; Al_{0.18-0.21}Nb_{0.18-0.21}Pt_{0.2}Ta_{0.18-0.21}Ti_{0.18-0.21}B₂; Al_{0.18-0.21}Nb_{0.18-0.21}Pt_{0.18-0.21}Ta_{0.2}Ti_{0.18-0.21}B₂; and Al_{0.18-0.21}Nb_{0.18-0.21}Pt_{0.18}-0.21Ta_{0.18-0.21}Ti_{0.2}B₂.

Particular embodiments include methods of enhancing the catalytic properties of a platinum group metal by forcing the platinum group metal into a high entropy alloy with boron. Forcing a platinum group metal into a high entropy alloy with boron can be achieved using, for example, a flux growth method. Flux growth typically refers to a process wherein an inorganic solid at room temperature functions as a solvent at higher temperatures at which crystals are obtained. In embodiments, the inorganic solid can include aluminum (Al) or gallium (Ga). The flux is the high temperature solution that functions as the solvent for crystallization. For additional general information regarding flux growth methods, see Juillerat et al., Dalton Transactions, DT-FRO 11-2018-004675.R1.

Forcing the platinum group metal into a high entropy alloy with boron can also be achieved using flux growth methods with elemental powders. The mixed materials can be heated, for example, within the range of 700° C.-2000° C., or 900° C.-1100° C. with a heating profile at a rate of 1-10° C./min, 1-8° C./min, 1-6° C./min, 1-4° C./min, 2-10° C./min, 4-10° C./min, 6-10° C./min, 8-10° C./min, 3-10° C./min, 3-7° C./min, 5-10° C./min, or 5-7° C./min, for more than 2 hours, 2-24 hours, 2-20 hours, 2-16 hours, 2-12 hours, 2-8 hours, 2-4 hours, 6-24 hours, 10-24 hours, 14-24 hours, 18-24 hours, 22-24 hours, 5-20 hours, or 10-15 hours; followed by cooling at a rate of 5° C./min until room temperature is reached. In embodiments, room temperature can include 20° C., 21° C., 22° C., 23° C. and 24° C.

### Exemplary Embodiments

1. A high entropy boride-platinum group metal alloy including boron (B), a platinum group metal, and at least three metals selected from the group consisting of aluminum (Al), niobium (Nb), tantalum (Ta), and titanium (Ti).
2. The high entropy boride-platinum group metal alloy of embodiment 1, wherein the platinum group metal includes platinum (Pt), rhodium (Rh), palladium (Pd), ruthenium (Ru), iridium (Ir), or osmium (Os).
3. The high entropy boride-platinum group metal alloy of embodiment 1 or 2, wherein the platinum group metal includes Pt.
4. The high entropy boride-platinum group metal alloy of any of embodiments 1-3, wherein the at least three metals include Al, Nb, Ta, and Ti and the platinum group metal includes Pt.
5. The high entropy boride-platinum group metal alloy of any of embodiments 1-4, wherein an atomic ratio of Al to B within the high entropy boride-platinum group metal alloy is 0.2:2.
6. The high entropy boride-platinum group metal alloy of any of embodiments 1-5, wherein an atomic ratio of Nb to B within the high entropy boride-platinum group metal alloy is 0.2:2.
7. The high entropy boride-platinum group metal alloy of any of embodiments 1-6, wherein an atomic ratio of Ta to B within the high entropy boride-platinum group metal alloy is 0.2:2.
8. The high entropy boride-platinum group metal alloy of any of embodiments 1-7, wherein an atomic ratio of Ti to B within the high entropy boride-platinum group metal alloy is 0.2:2.
9. The high entropy boride-platinum group metal alloy of any of embodiments 1-8, wherein an atomic ratio of Pt to B within the high entropy boride-platinum group metal alloy is 0.2:2.
10. The high entropy boride-platinum group metal alloy of any of embodiments 1-9, wherein an atomic ratio for each of Al, Nb, Ta and Ti to B within the high entropy boride-platinum group metal alloy is 0.2:2.
11. The high entropy boride-platinum group metal alloy of any of embodiments 1-10, including Al_{0.2}Nb_{0.2}Pt_{0.2}Ta_{0.2}Ti_{0.2}B₂.
12. A method of enhancing the catalytic properties of a platinum group metal, the method including forcing the platinum group metal into a high entropy alloy including boron.
13. The method of embodiment 12, wherein the enhanced catalytic property reduces platinum group metal agglomeration.
14. The method of embodiment 12 or 13, wherein the enhanced catalytic property reduces carbonaceous coke coating.
15. The method of any of embodiments 12-14, wherein the forcing includes flux growth of the high entropy alloy.
16. The method of embodiment 15, wherein the flux growth includes:
grinding a pure elemental powder of a platinum group metal, a pure elemental powder of boron; and a pure elemental flux powder to form a uniform mixture of the powders;
heating the uniform mixture to form a sample including the high entropy alloy and a flux;
cooling the sample; and
separating the flux from the high entropy alloy.
   17. The method of embodiment 16, wherein the flux powder includes aluminum.
   18. The method of embodiment 16 or 17, wherein the heating includes:
increasing a temperature of the uniform mixture at a rate of 1° C./min to 10° C./min to a temperature of 700° C. to 2500° C.; and
maintaining the temperature for greater than 2 hours.
   19. The method of embodiment 18, wherein the temperature is to 900° C. to 1100° C.
   20. The method of any of embodiments 16-19, wherein the cooling includes decreasing a temperature of the sample at a rate of 5° C./min until room temperature is reached.

Experimental Example. Methods. Catalyst Preparation. The high entropy boride (HEB) of Al_{0.2}Nb_{0.2}Pt_{0.2}Ta_{0.2}Ti_{0.2}B₂ was prepared via flux growth method using pure elemental powders with 10 mmol additional aluminum powder to be used as a flux (typical loadings can be found in Table 1).

TABLE 1
Starting Materials and Typical Loading

| | | Metal | Mesh | | Mass |
|---|---|---|---|---|---|
| Element | Company | Basis | Rating | mmol | [mg] |
| Al | Thermo Scientific | 99.97% | 100 + 325 | 10.2 | 275.30 |
| Nb | Beantown Chemical Inc | 99.99% | 325 | 0.2 | 18.59 |
| Pt | Strem Chemicals Inc. | 99.00% | N/A | 0.2 | 39.02 |
| Ta | Beantown Chemical Inc. | 99.95% | N/A | 0.2 | 36.18 |
| Ti | Alfa Aesar | 99.40% | 100 | 0.2 | 9.60 |
| B | Alfa Aesar | 98.00% | 325 | 2 | 21.63 |

The powders were stoichiometrically ground in an agate mortar and pestle, supplemented with acetone to uniformly mix the materials. Once acetone had dried, the sample was pressed into a 10 mm diameter pellet and placed into an alumina boat. The alumina boat was then placed into a Lindberg Blue tube furnace capable of reaching 1000° C. alongside an upstream titanium rod to getter oxygen at high temperatures and further protect the sample from oxidation. A constant slow stream of argon was pushed through the tube furnace throughout the heating process. The heating profile consisted of a 6-hour room temperature purge to remove adsorbed water/oxygen; heat to 1000° C. at a rate of 5° C./min; hold 1000° C. for 24 hours; and finally cool to room temperature at a rate of 5° C./min.

At the conclusion of the heating cycle in the tube furnace, the pellet was etched in 6 M NaOH submerged in an ice bath for 48 hours to remove the aluminum flux from the sample. Afterward, the sample was centrifuged for 3 minutes at 4000 RPM with the top 25 mL layer discarded. The sample was topped off to 30 mL again with deionized water. This process was repeated three times with 15 mL acetone to remove any aqueous substrate from the sample. The sample was then placed in a vacuum oven for four hours to fully dry the sample.

Catalytic Reduction of 1-tert-butyl-4-nitrobenzene. The HEB catalyst (1.3 mg, 0.01 mmol) was added to a solution of 0.2 mmol 1-tert-butyl-4-nitrobenzene in 2 mL methanol. The vessel was pressurized with hydrogen gas to 1 atm. The reaction mixture was stirred at room temperature under H₂ and monitored by thin layer chromatography (TLC) for 14 hours. The reaction mixture was filtered using a Buchner funnel, followed by an extraction with dichloromethane (DCM) and saturated NaHCO₃. The combined organic layers were washed with brine and water then dried with anhydrous Na₂SO₄. The solvent was removed with a rotary evaporator to give the crude mixture. The crude mixture was purified by flash column chromatography to afford pure 4-tert-butylaniline (Rf=0.28, ethyl acetate:hexane=1:5).

Catalytic Reduction of 4-nitrothiophenol. HEB catalyst (1.3 mg, 0.01 mmol) was added to a solution of 0.2 mmol 4-nitrothiophenol in 2 mL methanol. The vessel was pressurized with hydrogen gas to 1 atm. The reaction mixture was stirred at room temperature under H₂ and monitored by TLC for 14 hours. The reaction mixture was filtered with a Büchner funnel, and then the solvent was removed with a rotary evaporator to give the crude mixture for NMR characterization without further purification.

Sample Characterization Instrumentation. Sample characterization was performed using powder X-ray diffraction (Rigaku Miniflex 6T), scanning electron microscope (Regulus 8100 Scanning Electron Microscope) coupled with energy-dispersive X-ray spectroscopy (Octane Elect EDS). Organic products were characterized by NMR (Bruker Avance 500 MHZ).

Results. Confirming the Structure of Al_{0.2}Nb_{0.2}Pt_{0.2}Ta_{0.2}Ti_{0.2}B₂. To prepare a high entropy phase where the entropy forces the platinum into a diboride structure, four other metals of Al, Nb, Ta, and Ti were chosen, all of which readily crystallize into the diboride structure. Furthermore, their sizes are comparable, while collectively giving a metallic radii difference of less than 15% from platinum, encouraging a single solid phase compound (Table 2) (Rahm, et al., J. Am. Chem. Soc. 2019, 141 (1), 342-351).

TABLE 2
Slater Radii of Metals

| | Metallic | Crystal | | |
|---|---|---|---|---|
| Metal | Radius [pm] | Structure | Electronegativity | Valency |
| Al | 143 | Diboride | 9.1 | High |
| Nb | 146 | Diboride | 7.0 | High |
| Ta | 146 | Diboride | 7.8 | High |
| Ti | 147 | Diboride | 8.4 | High |
| Pt | 138.5 | No Diboride | 9.5 | Low |

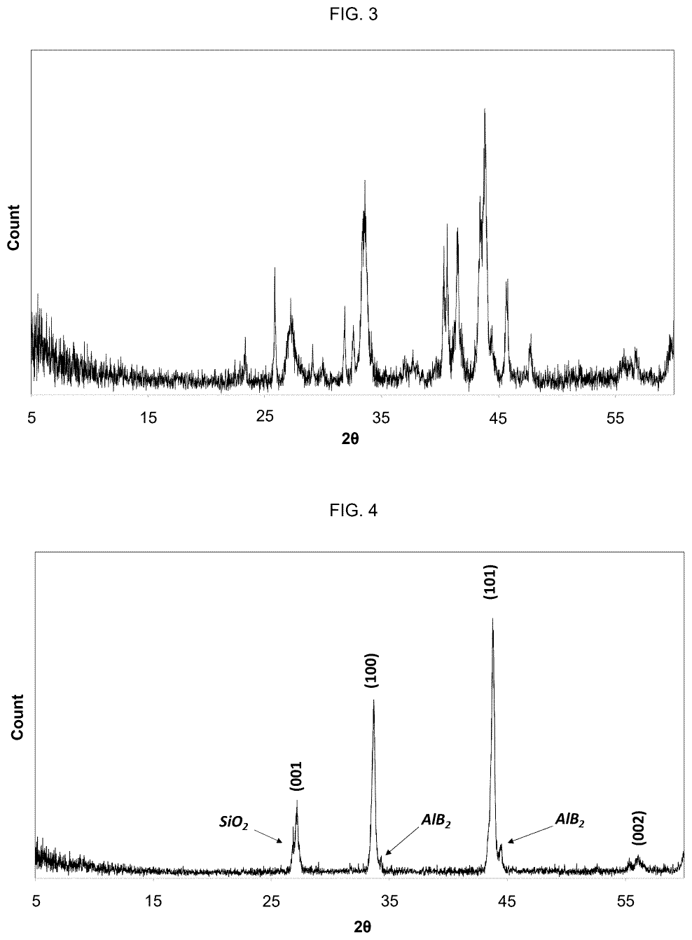

Indeed, these four elements readily crystallize into Al_{0.2}Nb_{0.2}Pt_{0.2}Ta_{0.2}Tl_{0.2}B₂ (FIG. 2). While all these aforementioned metals should readily crystallize into a diboride structure, platinum should not as there is no known platinum diboride, the electronegativity sits outside the range of electronegativities, and the valency of platinum is low as it is an inert metal. Unlike previous work on high entropy diborides which limited themselves to metals that are known to form diborides, here, platinum whose diboride is nonexistent was included (Feng, et al., Annu. Rev. Mater. Res. 2021, 51 (1), 165-185; Gild, et al., Sci. Rep. 2016, 6 (1), 37946). Indeed, groups IX-XII do not form diborides simply because high d-electron counts will perturb the planar borophene sheets, as can be seen with the progressive puckering and reduced coordination as one moves from TaB₂ (planar boron) to WB₂ (planar and chair boron) to ReB₂ (chair boron) to OsB₂ (boat boron). This “wall” prevents the formation of higher platinum group metal borides.

Attempting to directly prepare Al_{0.2}Nb_{0.2}Pt_{0.2}Ta_{0.2}Ti_{0.2}B₂ by simply heating from the elements failed owing to the chemical inertness of platinum (FIG. 3). Unreacted platinum is clearly seen in the pXRD pattern. To overcome this kinetic limitation of platinum incorporation, flux growth was used. Here, the molten aluminum flux serves two purposes: first, to dissolve the unreactive platinum and increase its lability and second, to favor the formation of borides as the excess aluminum shifts the chemical equilibrium towards the formation of borides. The HEB was prepared using a flux growth method due to previous work by others in synthesizing borides, primarily based on the synthesis of W_{0.5}Ta_{0.5}B (Yeung, et al., Appl. Phys. Lett. 2016, 109 (20), 20310). The molten aluminum dissolves boron, increasing its activity to allow for more interactions between the components. Upon cooling, the diboride precipitates from the solution due to saturation, forming a nanoparticle HEB (Yeung, et al., Appl. Phys. Lett. 2016, 109 (20), 20310).

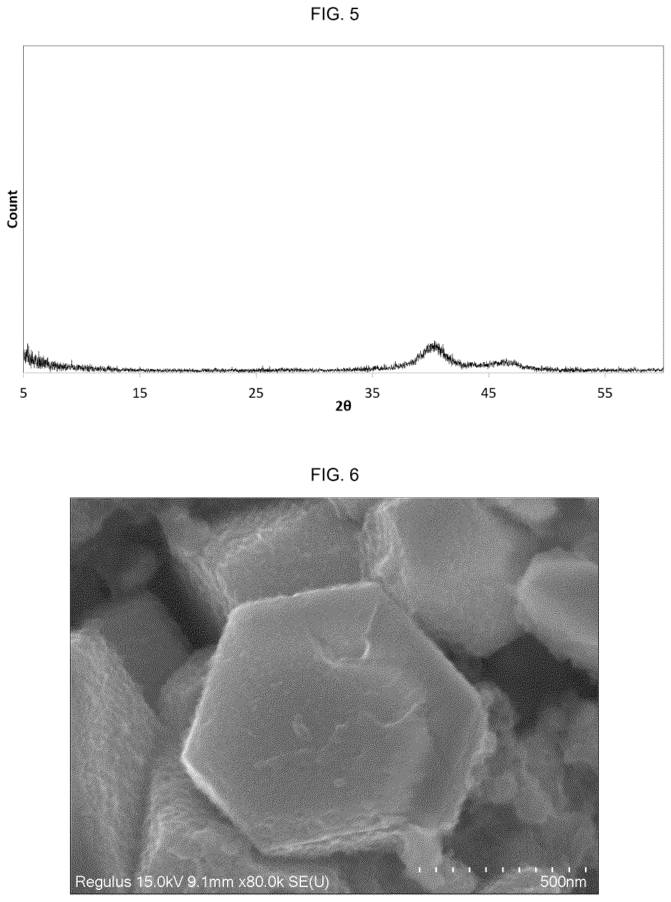

Powder X-ray diffraction (pXRD) was used to confirm the crystal system and identify whether the sample was phase pure, and diborides readily form from the molten flux so long as platinum is avoided. This can be seen with Al_{0.4}Nb_{0.2}Ta_{0.2}Ti_{0.2}B₂, which was a high entropy boride without platinum produced as a control to be used for the organic catalysis to ensure that platinum is required to catalyze the reactions (FIG. 4). To prove that platinum requires a high-entropy stabilization to go into a diboride and that simple Hume-Rothery solid solutions are nonexistent, a sample consisting of only aluminum, boron, and platinum was attempted to be created with the formula of Al_{0.8}Pt_{0.2}B₂ using identical synthesis parameters and protocol; here, aluminum has the closest atomic radii and electronegativity to platinum (Table 2), but the inherent inertness of platinum and lack of a platinum diboride precludes solid solution formation. The pXRD pattern (FIG. 5) only demonstrated peaks indicative of platinum metal decomposition products, but the diboride spectra did not persist which suggests that if the platinum diboride did exist, it promptly decomposes upon cooling, confirming the instability of platinum diborides. To that end, Al_{0.2}Nb_{0.2}Pt_{0.2}Ta_{0.2}Ti_{0.2}B₂ was successfully prepared from the molten flux. The pXRD pattern for a diboride species consists of three distinct peaks corresponding to the [001], [100], and miller indices with increasing intensity as 20 increases towards 60 degrees as expected of an MB₂ space group (191) P6/mmm (Golla, et al., Ultra-High Temperature Ceramics; John Wiley & Sons, Ltd, 2014; pp 316-360). Unit cell parameters were calculated by overlaying the model AlB₂-type structure onto the Al_{0.2}Nb_{0.2}Pt_{0.2}Ta_{0.2}Ti_{0.2}B₂ PXRD pattern (FIG. 2) and refining the unit cell to match the pattern's spacing. There are SiO₂ (ostensibly from grinding the diboride in an agate mortar and pestle for pXRD) and AlB₂ (from the aluminum flux) impurities. The lattice parameters were thus calculated as such: a=3.073 (2) Å and c=3.278 (1) Å. Here, platinum occupies the M site of MB₂, which makes Al_{0.2}Nb_{0.2}Pt_{0.2}Ta_{0.2}Tl_{0.2}B₂ the highest boron-coordinating platinum in the borides to date.

While the diffraction confirms a remarkable 12-coordinate platinum sandwiched between two hexagonal borophene sheets, the inherent chemical nobility of platinum still tempers the stability of the diboride structure. In some samples, there appears to be a poorly defined, broad peak seen at 40°. It was hypothesized that the extra peak comes from oxidation/corrosion of the surface of the catalysts, resulting in platinum exsolution and the potential formation of tiny platinum clusters. Indeed, the few platinum group metal diborides such as rhenium diboride (ReB₂) completely decompose in the presence of water and air (Granados-Fitch, et al., J. Am. Ceram. Soc. 2018, 101 (7), 3148-3155). It is noted that the HEB Al_{0.2}Nb_{0.2}Pt_{0.2}Ta_{0.2}Ti_{0.2}B₂ is significantly more stable than ReB₂ as the synthetic protocol requires complete immersion in caustic aqueous solutions in air. Furthermore, any potential platinum cluster formation is low given the low intensities as seen in the pXRD pattern (FIG. 2).

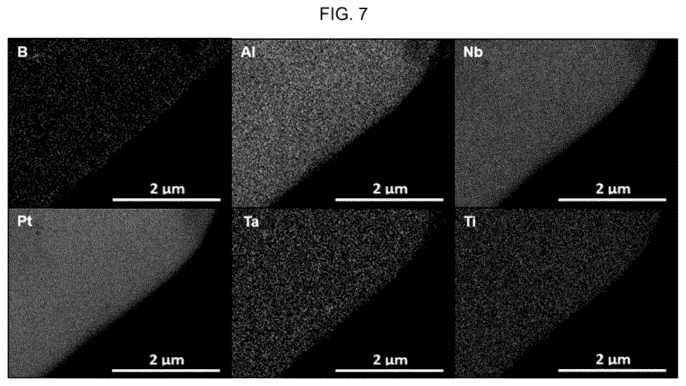

Scanning electron microscopy (SEM) images show that the sample is in a hexagonal crystal structure, as small hexagons were visibly present reflective of its crystal habit (FIG. 6). These tiny single crystals also reflect the high crystallinity and full incorporation of the metals. To confirm the even distribution of the metals, energy dispersive X-ray spectroscopy (EDS) was used in conjunction with SEM; EDS mapping displayed homogenous distribution of the elements (FIG. 7). While boron is shown to be fainter than the other elements, this can be attributed to it being a light element with less electron density, giving off a weaker signal in comparison to the heavier, higher-Z elements in this sample.

Catalysis. The catalytic hydrogenation of 1-tert-butyl-4-nitrobenzene was performed using Al_{0.2}Nb_{0.2}Pt_{0.2}Ta_{0.2}Ti_{0.2}B₂ as a catalyst, which was compared to a control of pure platinum powder. The reduction of aryl nitro groups to anilines is an industrially relevant reaction primarily for pesticides, dyes, and pharmaceuticals. This reaction is typically performed at slightly elevated temperatures (50-80° C.) and 3-5 atm of hydrogen, which is the preferred reductant since it is green (Gelder, et al., Chem. Commun. 2005, No. 4, 522-524; Blaser, et al., ChemCatChem 2009, 1 (2), 210-221). It was hypothesized that since the HEB catalyst has platinum atomically dispersed as a solid-solution, Al_{0.2}Nb_{0.2}Pt_{0.2}Ta_{0.2}Ti_{0.2}B₂ should be significantly more catalytically active and possibly achieve reduction at the more accessible ambient temperature and pressure (Dasgupta, et al., Nat. Chem. 2022, 14 (5), 523-529).

The HEB resulted in a yield of 93% with a TON (turnover number) of 92.89 (Scheme 1a), while pure platinum powder had a yield of 75% and a comparable TON of 75.42 (Scheme 1b) in their respective reductions to 4-tert-butylaniline. The HEB control Al_{0.4}Nb_{0.2}Ta_{0.2}Ti_{0.2}B₂ (which contains no platinum) was used to verify that platinum containing HEB was necessary to catalyze the hydrogenation, which resulted in no product formation (Scheme 1e). Turnover number was calculated based on platinum content for both HEB and the platinum powder control, which means that the TON values set the lower bound as surface, catalytically active platinum was overcounted; furthermore, operations were at the accessible conditions ambient pressure and temperature and well below industrial conditions of high hydrogen overpressures. Despite this, the platinum HEB is clearly more active than pure platinum, confirming that the atomically dispersed platinum solid solutions are more active, but the distinguishing feature of Al_{0.2}Nb_{0.2}Pt_{0.2}Ta_{0.2}Ti_{0.2}B₂ is its poison resistance. Sulfur is a strong catalytic poison as ppm levels are enough to completely deactivate a catalyst, but it was decided to test the absolute worst-case scenario where the substrate contains sulfur. Here, the equimolar sulfur content of nitrothiophenols dramatically exceeds ppm levels and will be the strongest test of Al_{0.2}Nb_{0.2}Pt_{0.2}Ta_{0.2}Ti_{0.2}B₂ poison resistance. The presence of sulfur functional groups also prevents product recovery as the thiol will strongly bind onto the catalyst. The only reported cases of using platinum to catalytically reduce nitrothiophenols were surface-enhanced Raman scattering kinetic studies where the reaction rate was monitored solely on the surface as the product was irrecoverable, furthermore, these studies used low reactant concentrations to avoid poisoning or employed the more catalytically active sodium borohydride as reductant (Schäfer, et al., J. Phys. Chem. C 2023, 127 (2), 1015-1022; Xie, et al., Angew. Chem. Int. Ed. 2016, 55 (44), 13729-13733; Xie, et al., J. Am. Chem. Soc. 2011, 133 (48), 19302-19305).

The catalytic hydrogenation of 4-nitrothiophenol using the HEB catalyst resulted in a mixture of 4-aminothiophenol and its corresponding disulfide product with yields of 18% and 17% respectively with a TON of 35, showing that the HEB was resistant to the poisonous nature of the thiol compound (Scheme 1c). The platinum powder control resulted in a yield of only 3% disulfide product and no 4-aminothiophenol with a TON 3 (Scheme 1d), showing that the platinum powder was ‘poisoned’ from the thiol compound and that any thiol containing product is irrecoverable. The HEB Al_{0.2}Nb_{0.2}Pt_{0.2}Ta_{0.2}Tl_{0.2}B₂ is thus shown to be resistant to sulfur poisoning and the ability to catalyze the hydrogenation reaction in the presence of the thiol functional group.

Clearly, platinum containing diborides maintains remarkable catalytic activity despite the presence of poisonous substrates. It was hypothesized that platinum is donating its catalytically active d-electrons to the borophene sheets, while the harder boron sheets serve to prevent the sulfur from binding onto the platinum as a sort of ‘protective blanket’ (Park, et al., J. Am. Chem. Soc. 2017, 139 (37), 12915-12918; Park, et al., Angew. Chem. Int. Ed. 2017, 56 (20), 5575-5578). The boron sheets are known to be conductive, and it would not be surprising to see d-electron transfer. This would be in line with previous work on boron doping of catalysts where the electron-deficient boron draws away some of the electron density from the metals (Mao, et al., ACS Catal. 2022, 12 (15), 8848-8856).

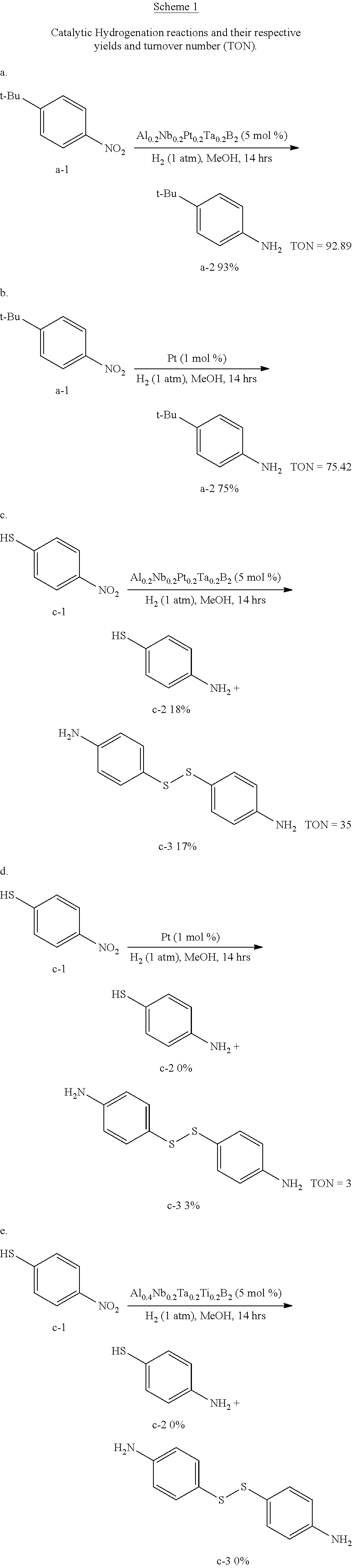

Summary There are two main restrictions that govern the chemistry and stability of solid-state materials: the Hume-Rothery rules (where alloys can only form when the crystal structure, radii, electronegativity, and valance are similar) and local electronic configuration (fully filled shells limit their bonding). Here, it is demonstrated that high entropy stabilization can overcome these limiting guidelines by growing Al_{0.2}Nb_{0.2}Pt_{0.2}Ta_{0.2}Ti_{0.2}B₂ crystals from molten flux. Furthermore, the borophene sheets serve as a structural protecting agent, and enables the reduction of thiol containing substrates that pure platinum cannot resolve. This suggests that heterogenous catalysts can be crystallographically designed to be poison resistant and further advances the area of reducing sulfur containing substrates such as thioethers, thioesters, and disulfides. Moreover, high entropy stabilization can overcome the inherent chemical reluctance and can open up the chemical phase space of alloys and intermetallics.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of +20% of the stated value; +19% of the stated value; +18% of the stated value; +17% of the stated value; +16% of the stated value; +15% of the stated value; +14% of the stated value; +13% of the stated value; +12% of the stated value; +11% of the stated value; +10% of the stated value; +9% of the stated value; +8% of the stated value; +7% of the stated value; +6% of the stated value; +5% of the stated value; +4% of the stated value; +3% of the stated value; +2% of the stated value; or +1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

1. A high entropy boride-platinum group metal alloy comprising Al_{0.2}Nb_{0.2}Pt_{0.2}Ta_{0.2}Ti_{0.2}B₂.

2. A high entropy boride-platinum group metal alloy comprising boron (B), a platinum group metal, and at least three metals selected from the group consisting of aluminum (Al), niobium (Nb), tantalum (Ta), and titanium (Ti).

3. The high entropy boride-platinum group metal alloy of claim 2, wherein the platinum group metal comprises platinum (Pt), rhodium (Rh), palladium (Pd), ruthenium (Ru), iridium (Ir), or osmium (Os).

4. The high entropy boride-platinum group metal alloy of claim 2, wherein the platinum group metal comprises Pt.

5. The high entropy boride-platinum group metal alloy of claim 2, wherein the at least three metals comprise Al, Nb, Ta, and Ti and the platinum group metal comprises Pt.

6. The high entropy boride-platinum group metal alloy of claim 2, wherein an atomic ratio of Al to B within the high entropy boride-platinum group metal alloy is 0.2:2.

7. The high entropy boride-platinum group metal alloy of claim 2, wherein an atomic ratio of Nb to B within the high entropy boride-platinum group metal alloy is 0.2:2.

8. The high entropy boride-platinum group metal alloy of claim 2, wherein an atomic ratio of Ta to B within the high entropy boride-platinum group metal alloy is 0.2:2.

9. The high entropy boride-platinum group metal alloy of claim 2, wherein an atomic ratio of Ti to B within the high entropy boride-platinum group metal alloy is 0.2:2.

10. The high entropy boride-platinum group metal alloy of claim 2, wherein an atomic ratio of Pt to B within the high entropy boride-platinum group metal alloy is 0.2:2.

11. The high entropy boride-platinum group metal alloy of claim 2, wherein an atomic ratio for each of Al, Nb, Ta and Ti to B within the high entropy boride-platinum group metal alloy is 0.2:2.

12. A method of enhancing catalytic properties of a platinum group metal, the method comprising forcing the platinum group metal into a high entropy alloy comprising boron.

13. The method of claim 12, wherein the enhanced catalytic property reduces platinum group metal agglomeration.

14. The method of claim 12, wherein the enhanced catalytic property reduces carbonaceous coke coating.

15. The method of claim 12, wherein the forcing comprises flux growth of the high entropy alloy.

16. The method of claim 15, wherein the flux growth comprises:
grinding a pure elemental powder of a platinum group metal, a pure elemental powder of boron; and a pure elemental flux powder to form a uniform mixture of the powders;
heating the uniform mixture to form a sample comprising the high entropy alloy and a flux;
cooling the sample; and
separating the flux from the high entropy alloy.

17. The method of claim 16, wherein the flux powder comprises aluminum.

18. The method of claim 16, wherein the heating comprises:
increasing a temperature of the uniform mixture at a rate of 1° C./min to 10° C./min to a temperature of 700° C. to 2500° C.; and
maintaining the temperature for greater than 2 hours.

19. The method of claim 18, wherein the temperature is 900° C. to 1100° C.

20. The method of claim 16, wherein the cooling comprises decreasing a temperature of the sample at a rate of 5° C./min until room temperature is reached.
